(19) United States
(12) Patent Application Publication
(10) Pub. No.: US 2007/0019574 A1
(43) Pub. Date: Jan. 25, 2007

(54) Wireless access point and method for operating the same

(76) Inventor: Yu-Chang Huang, Santa Clara, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/287,271

(22) Filed: Nov. 28, 2005

(30) Foreign Application Priority Data
Jul. 22, 2005 (TW) 94124900

(51) Int. Cl. H04B 7/00

(52) U.S. Cl. 370/310

(57) ABSTRACT

A wireless access point and a method for operating the same are proposed, in which a virtual bridging control module carried out by software is used to bridge a plurality of RF modules, and a virtual mapping table is used to record information of incoming and outgoing transmission packets, thereby establish ingg a seamless sequential wireless network environment. The throughput won't drop when hopping transmission is performed between each access point. The method comprises the steps of: inputting a wireless network packet; issuing an interrupt request to a processing unit; receiving the packet by using an RF module; monitoring the packet by using a virtual bridging control module; determining the type of the packet; establishing a virtual mapping table; switching the packet to another RF module; and finally sending the packet to the destination.

### BACKGROUND OF THE INVENTION

1. Field of the Invention

The present invention relates to a wireless access point and a method for operating the same and, more particularly, to a wireless access point and a method for operating the same, which use a virtual bridging control module to process a plurality of connections so as to establish a infrastructural wireless network.

2. Description of Related Art

Conventional network architectures include wired network systems and wireless network environments established on wired network bases. For instance, most client-end wireless web devices first connect to a wireless base station (e.g., a wireless access point installed somewhere) via a wireless distribution system (WDS), and then connect to some network environment. Each wireless access point is thus mutually connected via wired network. As shown in FIG. 1, wireless apparatuses 11, 12 and 13 (e.g., wireless access points) have signal processing units 11b, 12b and 13b coupled with RF modules 11a, 12a and 13a, respectively. The wireless apparatuses 11, 12 and 13 are connected together to form a wireless network 10 via their antennas 11c, 12c and 13c. This conventional wireless network, however, is based on a wired network 5 for mutual connection, as disclosed in U.S. Pat. No. 5,546,397.

FIG. 2 is a diagram of a network packet header disclosed in U.S. Pat. No. 5,570,366, in which a bridging apparatus looks up information of incoming and outgoing packets to accomplish the object of packet conversion and transmission. The header includes a media access control (MAC) header 20 of a network adapter, an Internet protocol (IP) header 21, a transmission control protocol (TCP) header 22, and data 23. The MAC header 20 further includes a destination MAC address 201, a source MAC address 202, and a packet type 203. The packet type 203 is filled with a type code of packet. Packets of different types include TCP/IP packets, wireless IEEE802.1x packets, and so on. The IP header 21 and the TCP header 22 are filled with the source and destination IP addresses of the packet and messages such as version, header length, time to live, protocol, and network port.

When a packet is transmitted to a destination address from the source end, it usually passes a plurality of network bridging apparatuses, whose function is to modify the source and destination addresses of the header content of the packet to facilitate transmission through each bridging apparatus and establish a mapping table in each apparatus. The network bridging apparatus looks up a table to modify information contained in the header when a packet passing by so that the packet can be correctly transmitted to and fro.

A local area network (LAN) apparatus makes use of the above MAC address for discrimination and connection of each apparatus for mutual transmission of packets. When a LAN apparatus transmits a packet, the source and destination MAC addresses corresponding to the packet are attached to the header so that the packet can successfully arrive at the destination. When a packet is transmitted in network, the header of the packet needs to contain the source and destination MAC addresses. If the packet is to be transmitted between different network segments, it is necessary to install several apparatuses for bridging different network segments in between. The above wireless access points can be used as bridging apparatuses for packet transmission to carry out relay of different network segments. Exchange of packet can be accomplished by using a learning table including the segment addresses and the source and destination MAC addresses.

For the transmission of packet between wireless access points, the present standard is IEEE 802.11. When a wireless network apparatus operates, it first connects to a wireless access point (AP). The address of this AP is used as the destination address first. That is, the destination address field of the packet header is filled with the MAC address of the network adapter of this AP. The final destination address to which the packet is to be transmitted is still stored in the header. Next, the AP determines the exchanged address of the packet. At this time, the AP changes the source address in the packet header to the address of the AP, and transmits the packet according to the destination address therein. The above packet transmission technique utilizes MAC addresses of three network adapters of the source end, the destination end, and the AP. When two APs achieve connection via the WDS, MAC addresses of four network adapters (of the source end, the destination end, and the two APs) are required.

As stated above, because wireless APs makes use of the WDS for packet transmission, they have the following disadvantages:
(1) The WDS has an upper limit to the number of connection session so that seamless packet transmission cannot be performed.
(2) Dynamic encryption mechanisms cannot be used under the WDS. Only the fixed WEP key can be provided, hence being vulnerable to hacking. If wireless apparatuses need to use IEEE 802.1x for security protection, the WDS cannot be used for packet transmission.
(3) The network throughput can only reach about one thirds of the achievable maximum value of the wireless apparatus.

In the prior art, when a user uses an AP to get online (this is called the station mode), he cannot send out the source information of packets. On the other hand, when a plurality of wireless APs achieves mutual connection (this is called the AP mode), because they need to share the bandwidth by means of handshaking, the performance will decrease. Moreover, because packets are transmitted between the APs by means of hopping, the transmission speed is slowed down, and loss of the bandwidth occurs. The present invention provides a virtual bridging control module in the wireless AP. Through the use of a virtual mapping table, the station mode can be use for transmission between various APs to accomplish the advantages of low performance loss and high throughput, thereby building a daisy-chained infrastructural wireless network.

### SUMMARY OF THE INVENTION

An object of the present invention is to provide a wireless access point and a method for operating the same to solve the problem occurred in the prior art that the network transmission efficiency and throughput will decrease due to mutual sharing of bandwidth between two wireless access points when wireless transmission of packets is in process. The present invention establishes virtual bridging control module in the wireless access point, and makes use of the station-access point architecture (the station mode). The present invention also uses a mapping table to record information of incoming and outgoing packets so as to establish a daisy-chained wireless network environment.

In order to seamlessly achieve a sequential wireless network environment in which the throughput won't decrease when performing packet hopping between various wireless access points, a preferred embodiment of the present invention uses a virtual bridging control module carried out by software to process a plurality of wireless network connections. The wireless access point of the present invention comprises a plurality of RF modules having the multiplex function, a virtual bridging control module coupled with the RF modules, a network transmission module, and a processing unit. The virtual bridging control module generates a realtime virtual mapping table corresponding to transmission routes of incoming and outgoing packets. The network transmission module is coupled with the virtual bridging control module. The processing unit performs decoding/encoding of packet and modification of source and destination IP addresses or MAC addresses. The wireless access point of the present invention integrates a plurality of RF modules, and cascades other wireless access points to establish a daisy-chained wireless network environment.

The method for operating a wireless access point of the present invention comprises the steps of: inputting a wireless network packet to a wireless access point; issuing an interrupt request to a processing unit; receiving the wireless network packet by using an RF module; monitoring the wireless network packet by using a virtual bridging control module carried out by software; determining whether the type of the packet belongs to those that can be processed by the wireless access point; establishing or modifying a virtual mapping table to record header information of the packet; switching to another RF module according to the information of the packet recorded by the virtual mapping table; and transmitting the packet to the destination.

When the packet captured by the virtual bridging control module in the wireless access point of the present invention is sent out by an operating system in the wireless access point, the packet is sent out by the operating system or the network transmission module in the wireless access point. Next, the virtual bridging control module captures the packet. Whether the packet is a broadcast packet and whether the packet is to be processed are then determined. After the determination, if the packet is one that can be processed by this embodiment, information such as the source and destination is read out from the header of the packet. Next, whether the information of the packet exists in a virtual mapping table is then determined. If the information such as the source and destination of the packet exists in the virtual mapping table, the source information in the header of the packet is changed to the interface information that is to be sent out, and the packet is transmitted to an RF module to be emitted out. If the source information does not correspond to the interface information of the wireless access point, the information of the packet is added into the virtual mapping table. Finally, the packet is transmitted to the RF module to be emitted out.

When the packet captured by the virtual bridging control module of the wireless access point is received by an RF module, the wireless access point receives a packet by using the RF module, and the virtual bridging control module captures the received packet. Next, whether the packet is a broadcast packet and whether the packet is an IP packet are determined. If the packet is one that can be processed by the wireless access point of the present invention, whether information of the packet exists in a virtual mapping table is then checked. If the information of the packet does not exist in the virtual mapping table, the packet is transmitted to the operating system to be processed. If the information of the packet exists in the virtual mapping table, the information of the packet is modified according to the virtual mapping table. Finally, the packet is emitted out by another RF module or transmitted to the operating system to be processed.

### BRIEF DESCRIPTION OF THE DRAWINGS

The various objects and advantages of the present invention will be more readily understood from the following detailed description when read in conjunction with the appended drawing, in which:

FIG. 1 is a diagram of a wireless network system in the prior art;

FIG. 2 is a diagram of a network packet header in the prior art;

FIGS. 3A and 3B are a diagram of a wireless network architecture of the present invention;

FIG. 4 is a function block diagram of a wireless access point of the present invention;

FIG. 5 is a flowchart of the method for operating a wireless access point of the present invention;

FIG. 6 is a flowchart of the method for operating a wireless access point according to an embodiment of the present invention;

FIG. 7 is a flowchart of the method for operating a wireless access point of the present invention when the packet captured by a virtual bridging control module is sent out by the system; and

FIG. 8 is a flowchart of the method for operating a wireless access point of the present invention when the packet captured by a virtual bridging control module is received by the RF module.

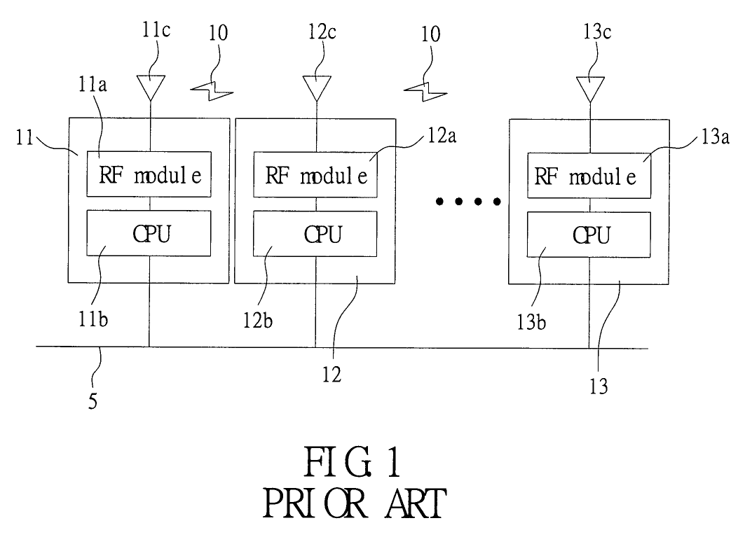

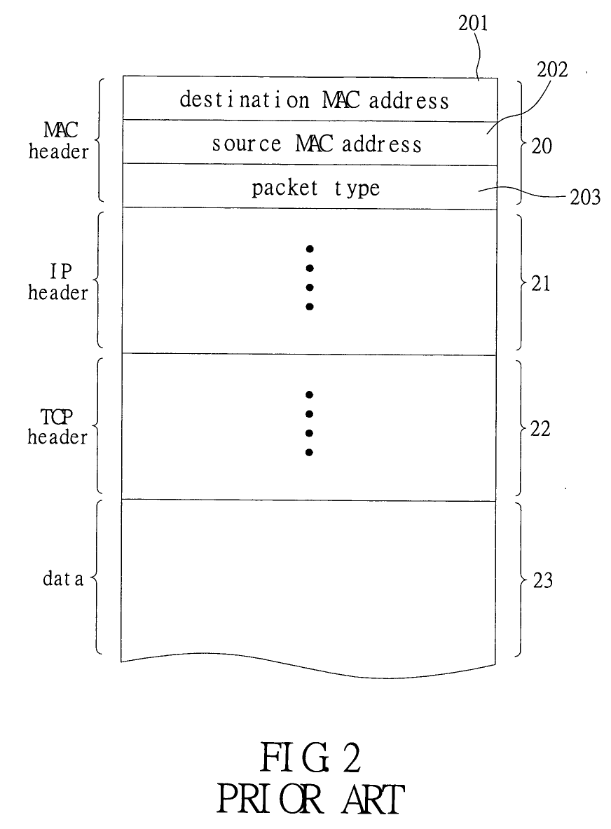

### DETAILED DESCRIPTION OF THE PREFERRED EMBODIMENTS

The present invention uses a virtual bridging control module carried out by software to provide a method for bridging a plurality of RF modules, and uses a virtual mapping table to record information of the source and destination of incoming and outgoing packets. The present invention makes use of a station/client-access point architecture to establish a seamless sequential wireless network environment so that the throughput won't drop when hopping transmission of packet is performed between each access point, hence improving the problem of performance loss occurred in the prior art because wireless access points need to wait for a response time when performing transmission of packet.

In the above station/client-access point architecture, it is only necessary for a wireless access point to provide the occupied bandwidth for the station (or called a client) under the station mode. On the other hand, two or more wireless access points shall have to share the bandwidth and work time under the AP mode because each wireless access point needs to share the bandwidth and work time with other devices in addition to meeting the bandwidth requirement of its client. When there is a signal connection, the present invention will make use of soft switch carried out by software to fast switch the connection to the RF module of another network connection, hence having no performance and bandwidth loss between conventional wireless access points.

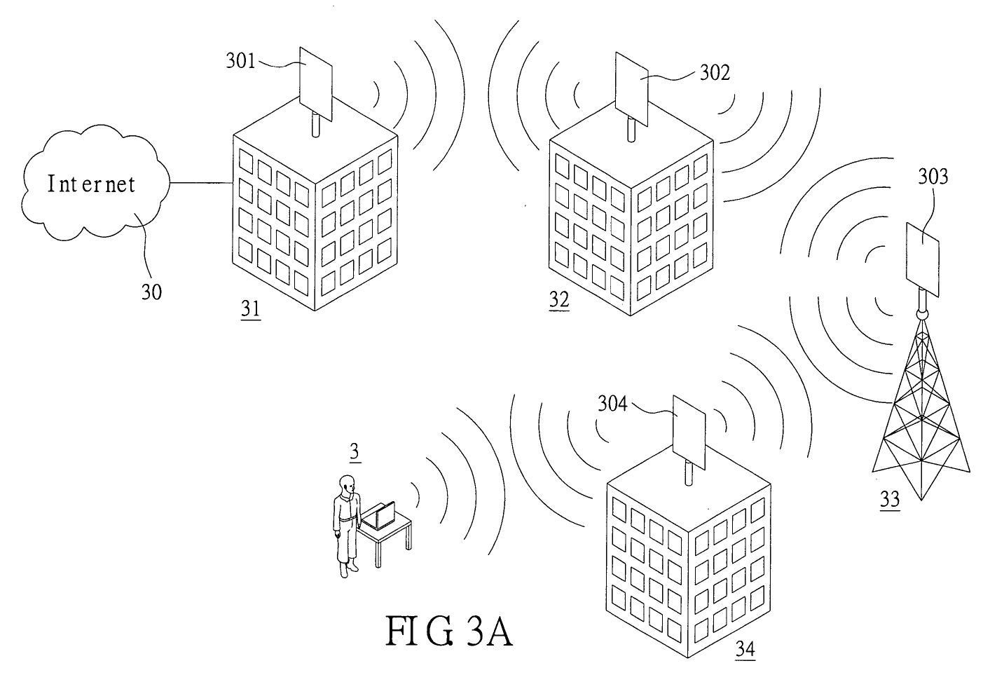

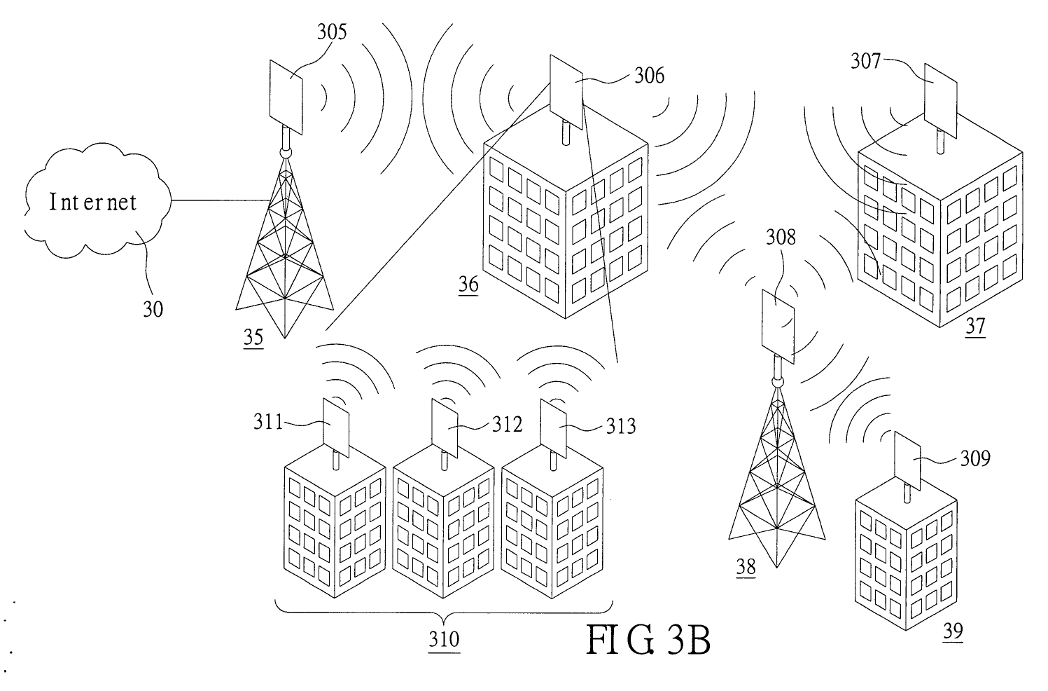

As shown in FIG. 3A, the present invention provides wireless access points 301, 302, 303 and 304 installed on buildings 31, 32 and 34 or a power tower 33. Through the daisy-chained architecture formed between them, a wireless network is established. When one end connects to the Internet 30, the user or any local area network (LAN) or wide area network (WAN) can wirelessly connects to the Internet 30 via any of the wireless access points 301, 302, 303 and 304. The wireless AP 302 has at least two RF modules used to bridge the wireless APs 303 and 301. Each RF module can provide connection for many other users. In this embodiment, the user 3 can connect to the Internet 30 via the wireless AP 304. In this architecture, the packets will pass in turn the power tower 33, the wireless AP 302, and the wireless AP 301 to connect to the Internet 30. Because a virtual bridging control module is provided in the wireless AP of the present invention, good transmission speed and performance can still be kept after accomplishing a plurality of hopping transmissions of packet.

As shown in FIG. 3B, a plurality of wireless APs 311, 312 and 313 on buildings forms a LAN 310. The LAN 310 can wirelessly connect to a wireless AP 306 on another building 36 and then connect to the wireless AP 305 on a power tower 35 and the Internet 30 via the wireless AP 306. The LAN 310 can also connect to other networks via the wireless AP 306, e.g., connect to a wireless AP 309 on a building 39 or a wireless AP 307 on a building 37 via a wireless AP 308 on a power tower 38.

In this embodiment, the wireless AP 306 of the building 36 has three connection directions, and makes use of at least RF modules to separately process connections from different wireless APs 305 and 308 and the LAN 310. The wireless AP 308 of the power tower 38 has also at least two RF modules to process connections from the wireless APs 306 and 307. Through the switch mechanism carried out by the virtual mapping table of the virtual bridging control module, high throughput and transmission performance can still be kept during packet exchange.

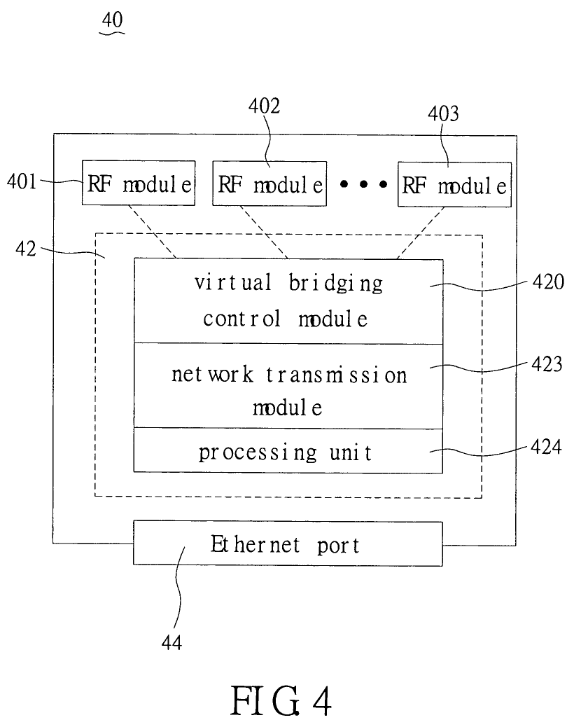

The present invention provides a wireless AP for bridging a plurality of RF modules to establish a point-to-point, a point-to-multipoint, or a daisy-chained wireless network environment. Under this architecture, the operation efficiency won't drop due to mutual connection of several apparatuses, and a stable connection quality with a high throughput can be established in a continually expanding wireless network environment. As shown in FIG. 4, a wireless AP 40 comprises a plurality of RF modules 401, 402 and 403 having the multiplex function. Each RF module, a network transmission module 423 responsible for network transmission protocols, and a processing unit 424 together form a control unit 42 of the wireless AP 40. This control unit 42 is further coupled with an Ethernet port 44 to cascade another wired network or a device therein (not shown). Users can connect to this device via the Ethernet port 44.

Switching operation of the above RF modules 401, 402 and 403 is accomplished by a switch mechanism in a virtual bridging control module 420 disposed in the control unit 42. The virtual bridging control module 420 uses firmware or software to carry out a soft switch mechanism. The virtual bridging control module 420 is coupled with the RF modules 401, 402 and 403 to form a daisy-chained network architecture integrating a plurality of RF modules. The control unit 42 further includes the network transmission module 423 for controlling various transmission protocols and transmission ports. The network transmission module 423 is coupled with the above virtual bridging control module 420. Besides, The control unit 42 further includes the processing unit 424 for performing packet decoding/encoding, modification of source and destination IP addresses or MAC addresses, and packet attribute analysis.

Compared with the conventional wireless network technique in which the source information of packet cannot be sent out under the station mode, the above virtual bridging control module 420 can generate a realtime virtual mapping table during packet connection to correspond to the transmission route of each incoming and outgoing packet. In other words, after a packet is received by the wireless AP 40 of the present invention, MAC addresses or IP addresses of the network adapters of the source and destination are recorded according to the header of the packet. For example, when there is a wireless packet passes the RF module 401 of the wireless AP 40, a virtual mapping table is established or modified to record the source and destination information of the packet, and the packet is exchanged to another RF module 402 through the switch mechanism therein to be transmitted to the destination. During transmission of packet, the source and destination of incoming and outgoing packets can readily be known based on the virtual mapping table. When switching to another RF module, the packet is immediately sent to the next AP without the need of considering bandwidth sharing with other wireless APs. Moreover, the packet is only processed by the virtual bridging control module 420 carried out by software without the need of hardware like processing unit, and it is not necessary for the packet to go to the Ethernet to be exchanged by the operating system. Therefore, loss of performance can be reduced, and a high throughput can be kept.

The virtual mapping table used in the above virtual bridging control module also solves the problem that the MAC address of the network adapter of the source cannot be effectively corresponded to when conventional APs exchange the packet by using a learning table.

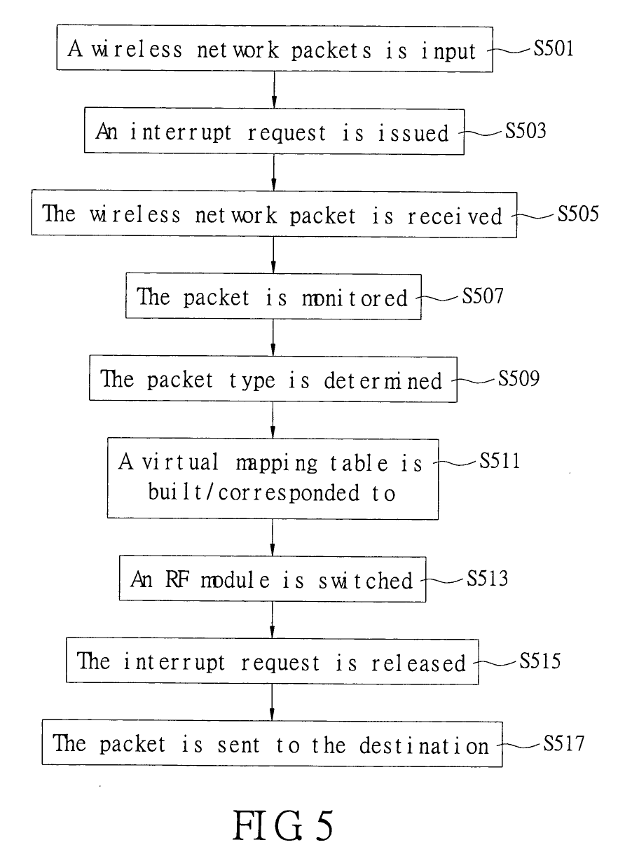

FIG. 5 is a flowchart of the method for operating a wireless access point of the present invention. First, a packet source generates a wireless network packet and inputs to a wireless AP to be received by an antenna (Step S501). Meanwhile, the corresponding RF module issues an interrupt request to the processing unit through an operating system (OS), i.e., a priority processing order of an RF module is demanded to the processing unit. A signal is sent to the processing unit to demand the processing unit to temporarily stop the present work and transfer the working priority of the RF module to this packet (Step S503). This RF module then receives and processes this wireless network packet (Step S505). Next, the virtual bridging control module carried out by software monitors this packet (Step S507), and analyzes the type of this packet to determine whether the packet is one that can be processed by the wireless AP (Step S509). For example, it is necessary to discard the IPX packet if the packet is of TCP/IP type.

After determination of the type of the packet, the virtual bridging control module establishes or modifies a realtime virtual mapping table (Step S511) to record the source and destination information of the packet. Another RF module to be switched to is also recorded so that the virtual mapping table can be corresponded to at the right time and the packet can thus be received and transmitted by the appropriate module and interface. Afterwards, according to the information recorded in the virtual mapping table, the switch mechanism in the virtual bridging control module switches the responsible RF module to another appropriate RF module, and the packet transmission operation is then switched to this RF module (Step S513). At this time, the original RF module releases the interrupt request to prepare for the interrupt request of the next connection (Step S515). Finally, the RF module switched to transmits the packet to the destination (Step S517).

The reply packet or the related connection emitted by the destination of the packet also passes the wireless AP, and corresponds to the source and destination of the packet by means of the virtual mapping table established by the virtual bridging control module to be switched to an appropriate RF module and then be emitted out.

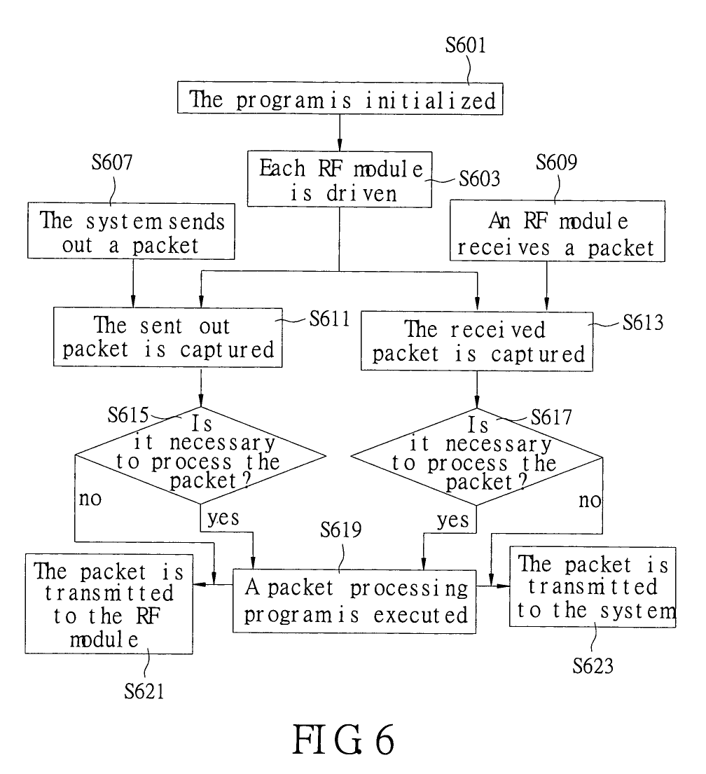

FIG. 6 is a flowchart of the method for operating a wireless access point according to an embodiment of the present invention. A seamless wireless network environment of sequential hopping transmission is established through the following steps.

First, a packet processing program in the virtual bridging control module is initialized (Step S601). A plurality of RF modules (at least two RF modules) is then driven (Step S603). Next, the virtual bridging control module starts to monitor and analyze a packet received or transmitted by the wireless AP, including capturing the packet sent out by the AP (Step S611) and capturing the packet received by the AP (Step S613).

If the above transmitted packet is a data packet sent out by the OS or the network transmission module (e.g., TCP/IP module) in the wireless AP (as stated in Step S607), the virtual bridging control module of the wireless AP captures this packet (Step S611). After analysis, whether the packet is to be processed is determined according to the strategy set in the virtual bridging control module (Step S615). If the packet is to be processed, the packet processing program in the virtual bridging control module is performed (Step S619) to perform building/modification of the virtual mapping table, switching of RF module, and so on. Finally, the packet is transmitted to an RF module to be emitted out (Step S621). If the packet is not to be processed, the packet is directly emitted out by an RF module (Step S621) without performing the packet processing program.

If the received packet captured in Step S613 is received by an RF module (as stated in Step S609), whether the packet is to be processed is determined (Step S617). If the packet is to be processed, the packet processing program is performed (Step S619) to perform modification or correspondence of the virtual mapping table. Next, the packet is sent to the OS (Step S623). If the packet is not to be processed, the packet is directly sent to the OS (Step S623). If the OS cannot support the communication protocol of the packet, the packet is discarded (e.g., the IPX packet is discarded because the OS does not support it).

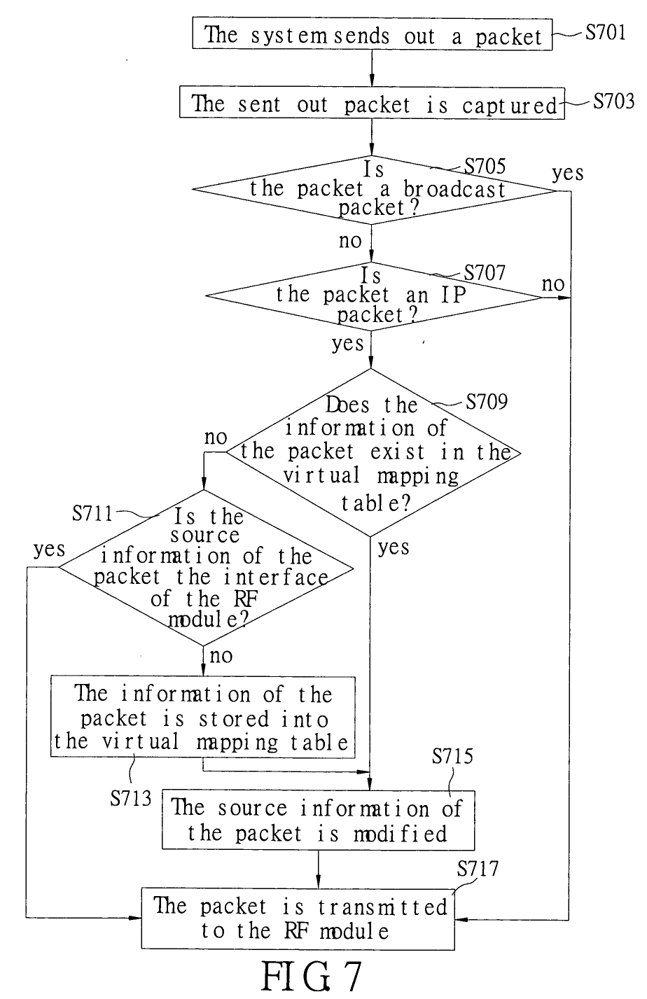

FIG. 7 is a flowchart of the method for operating a wireless access point of the present invention when the packet captured by a virtual bridging control module is sent out by the OS in the wireless AP. First, the OS or the network transmission module in the wireless AP sends out the packet (Step S701). The packet is then captured by the virtual bridging control module (Step S703). Next, the virtual bridging control module determines the type of the packet (e.g., whether the packet is a broadcast packet) (Step S705). If the packet is a broadcast packet instead of the packet types to be processed by this embodiment, the packet is transmitted to an RF module to be emitted out (Step S717). If the packet is not a broadcast packet, whether the packet is an Internet protocol (IP) packet to be processed by this embodiment is further determined (Step S707). If the packet is not an IP packet, this packet is transmitted to an RF module to be emitted (Step S717). If the packet is an IP packet, Step S709 is carried out.

In Step S709, the source and destination information of the packet are read out from the header of the packet, and whether information of the packet exists in the virtual mapping table is checked. In a preferred embodiment, when checking whether information of the packet exists in the virtual mapping table, it is necessary to update the time for establishing the virtual mapping table (e.g., by a maintenance program that is executed regularly), and too long time for establishing packet information (e.g., 30 sec) is searched out and cleared to reduce the space used by the virtual mapping table. Moreover, the virtual mapping table of the source or destination apparatus of the sent out packet is cleared to enhance the processing efficiency of the wireless AP. After the above checking step, if the source and destination information of the packet does indeed exist in the virtual mapping table, the source information in the header of the packet is changed to the information of the interface to be sent to (Step S715). If the source and destination information of the packet does not exist in the virtual mapping table, meaning the virtual mapping table does not record the information of the packet, whether the source information (e.g., the MAC address) in the packet corresponds to the interface information of the wireless AP is determined (Step S711). If the source information (e.g., the MAC address) in the packet corresponds to the interface information of the wireless AP, the packet is transmitted to an RF module to be emitted out (Step S717). If the source information (e.g., the MAC address) in the packet does not correspond to the interface information of the wireless AP, the information (including the source and destination MAC addresses, the IP addresses, and the time for establishing the virtual mapping table of the packet) of the packet is added into the virtual mapping table (Step S713). Next, the source information in the header of the packet is changed to the interface information that is to be sent out (Step S715). Finally, the packet is transmitted to an RF module to be emitted out (e.g., to the destination) (Step S717).

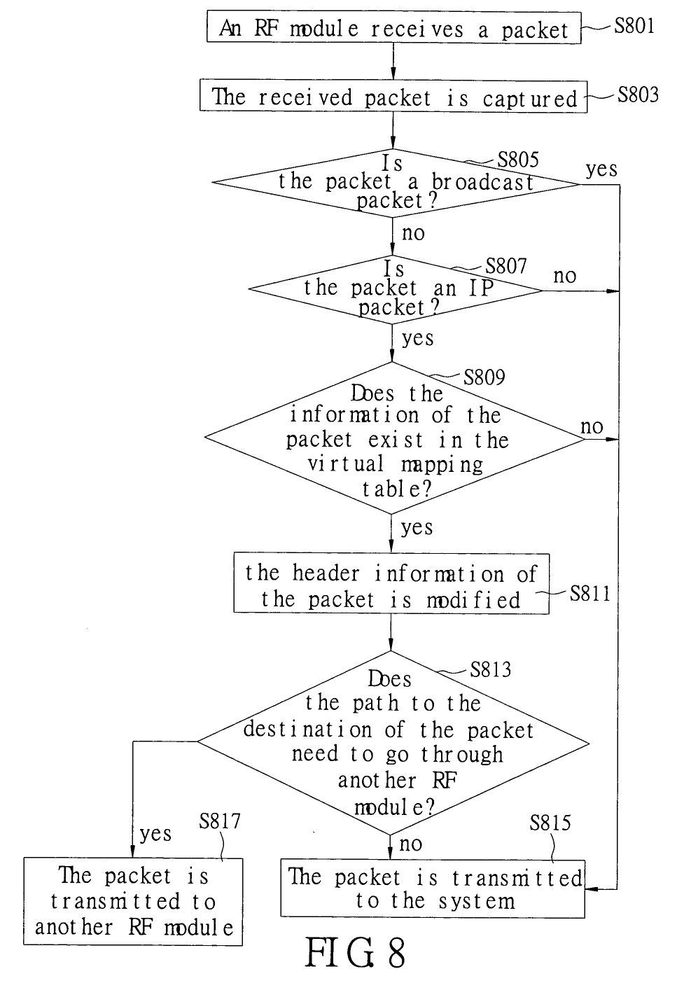

FIG. 8 is a flowchart of the method for operating a wireless access point of the present invention when the packet captured by a virtual bridging control module is received by an RF module. First, the wireless AP receives the packet via the RF module (Step S801). The virtual bridging control module then captures the received packet (Step S803). Next, the type of the packet is determined, e.g., whether the packet is a broadcast packet is determined (Step S805). If the packet is a broadcast packet, the packet is transmitted to the OS in the wireless AP to be processed (Step S815). In a preferred embodiment of the present invention, if the OS cannot support the communication protocol of the packet, the packet is discarded; otherwise, the OS processes the packet and then sends the packet out via its Ethernet, or the procedures starting from the Step S701 shown in FIG. 7 are carried out. If the packet is not a broadcast packet, whether the packet is an IP packet is further determined (Step S807). If the packet is not an IP packet, meaning the packet is not one that is to be processed by the virtual bridging control module, the packet is transmitted to the OS to be processed (Step S815). In a preferred embodiment of the present invention, if the OS does not support the communication protocol of the packet, the packet is discarded. otherwise, the OS processes the packet and then sends the packet out via its Ethernet, or the procedures starting from the Step S701 shown in FIG. 7 are carried out. If the packet is an IP packet, whether the packet information exists in the virtual mapping table is checked. In a preferred embodiment, when checking whether information of the packet exists in the virtual mapping table, it is necessary to update the time for establishing the virtual mapping table (e.g., by a maintenance program that is executed regularly), and too long time for establishing the packet information is searched out and cleared to reduce the space used by the virtual mapping table. Moreover, the virtual mapping table of the source or destination apparatus of the sent out packet is cleared to enhance the processing efficiency of the wireless AP.

If the information (e.g., the source and destination of the packet) contained in the IP packet does not exist in the virtual mapping table, the IP packet is transmitted to the OS to be processed (Step S815). Similarly, in a preferred embodiment, if the OS does not support the communication protocol of the packet, the packet is discarded. otherwise, the OS processes the packet and then sends the packet out via its Ethernet, or the procedures starting from the Step S701 shown in FIG. 7 are carried out. If the information contained in the IP packet exists in the virtual mapping table, the information in the virtual mapping table is first read out, and the header information of the packet is changed to the information in the virtual mapping table (Step S811). The destination of the packet is determined according to this information to decide whether to transmit the packet via another RF module of the wireless AP (Step S813). If it is not necessary to transmit the packet to another RF module, the packet is transmitted to the OS to be processed (Step S815). In a preferred embodiment, if the OS does not support the communication protocol of the packet, the packet is discarded. otherwise, the OS processes the packet and then sends the packet out via its Ethernet, or the procedures starting from the Step S701 shown in FIG. 7 are carried out. If it is decided according to the information of the packet that the packet needs to be transmitted via another RF module, the packet is transmitted to. an RF module of the wireless AP to be emitted out (Step S817).

To sum up, the present invention discloses a wireless AP and a method for operating the same, in which a virtual bridging control module carried out by software is provided in a wireless AP to establish a virtual mapping table for recording information of incoming and outgoing packets. A mechanism for switching various RF modules is also provided to established a seamless sequential wireless network environment so that the throughput won't drop when hopping transmission is performed between each access point.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. A wireless access point comprising:
at least two RF modules having the multiplex function;
a virtual bridging control module carried out by software, said virtual bridging control module being coupled with said RF modules, said virtual bridging control module generating a realtime virtual mapping table corresponding to transmission paths of incoming and outgoing packets, said virtual bridging control module including a switch mechanism for switching said RF modules;
a network transmission module coupled with said virtual bridging control module; and
a processing unit coupled with said network transmission module and used to process information of each packet;
whereby said wireless access point integrates said RF modules, and establishes a daisy-chained infrastructural wireless network environment through cascading other wireless access points.

2. The wireless access point as claimed in claim 1, further comprising an Ethernet port, wherein said Ethernet port is used for cascading another wired local area network or a device therein.

3. The wireless access point as claimed in claim 1, wherein said switch mechanism is accomplished by software.

4. A method for operating a wireless access point, said method being carried out by using the wireless access point as claimed in claim 1, said method comprising the steps of:
inputting a wireless network packet to said wireless access point; issuing an interrupt request;
receiving said wireless network packet by using an RF module;
monitoring said wireless network packet by using a virtual bridging control module carried out by software;
determining whether the type of said packet belongs to those that can be processed by said wireless access point;
establishing or modifying a virtual mapping table to record header information of said packet;
switching to another RF module according to the information of said packet recorded by said virtual mapping table; and
transmitting said packet to a destination.

5. The method for operating a wireless access point as claimed in claim 4, wherein in said step of issuing an interrupt request, an RF module issues said interrupt request to a processing unit via an operation system.

6. The method for operating a wireless access point as claimed in claim 4, wherein after said step of switching to another RF module, the original RF module immediately releases said interrupt request.

7. A method for operating a wireless access point, said method being carried out by using the wireless access point as claimed in claim 1, said method comprising the steps of:
initializing a packet processing program;
driving at least two RF modules disposed in said wireless access point;
monitoring a packet transmitted or received by said wireless access point by using a virtual bridging control module disposed in said wireless access point;
capturing said packet by using said virtual bridging control module of said wireless access point;
determining whether to process said packet;
executing said packet processing program in said virtual bridging control module; and
transmitting said packet.

8. The method for operating a wireless access point as claimed in claim 7, wherein in said step of capturing said packet, the packet received by said RF module is captured.

9. The method for operating a wireless access point as claimed in claim 7, wherein in said step of capturing said packet, said packet is sent out by an operating system in said wireless access point.

10. The method for operating a wireless access point as claimed in claim 7, wherein in said step of capturing said packet, said packet is sent out by a network transmission module of said wireless access point.

11. The method for operating a wireless access point as claimed in claim 7, wherein said packet processing program performs establishment and modification of a virtual mapping table and switching of said RF module, and finally transmits said packet to said RF module so that said packet can be emitted out.

12. The method for operating a wireless access point as claimed in claim 7, wherein if the answer in said step of determining whether to process said packet is “no”, it is not necessary to execute said processing program, and said packet is directly emitted out by said RF module.

13. The method for operating a wireless access point as claimed in claim 7, wherein if the answer in said step of determining whether to process said packet is “no”, it is not necessary to execute said packet processing program, and said packet is transmitted to an operating system of said wireless access point.

14. The method for operating a wireless access point as claimed in claim 7, wherein if the packet captured by said virtual bridging control module of said wireless access point is sent out by an operating system or a network transmission module, said step of executing a packet processing program in said virtual bridging control module comprises the steps of:
determining the type of said packet;
checking whether information of said packet exists in a virtual mapping table;
modifying a source information in the information of said packet to be interface information if the information of said packet exists in said virtual mapping table;
determining whether the information of said packet has the interface information of said wireless access point;
establishing the information of said packet into said virtual mapping table;
modifying the source information of said packet; and
transmitting said packet to said RF module so that said packet can be emitted out.

15. The method for operating a wireless access point as claimed in claim 14, wherein said step of determining the type of said packet includes determining whether said packet is a broadcast packet and determining whether said packet is an IP packet.

16. The method for operating a wireless access point as claimed in claim 14, wherein if said packet is determined to be a broadcast packet in said step of determining the type of said packet, said packet is transmitted to said RF module to be emitted out.

17. The method for operating a wireless access point as claimed in claim 14, wherein if said packet is determined to be not an IP packet in said step of determining the type of said packet, said packet is transmitted to said RF module to be emitted out.

18. The method for operating a wireless access point as claimed in claim 14, wherein if the source information in said packet corresponds to the interface information of said wireless access point, said packet is transmitted to said RF module to be emitted out.

19. The method for operating a wireless access point as claimed in claim 14, wherein when checking whether information of said packet exists in said virtual mapping table, the time for establishing said virtual mapping table is immediately updated, and too long time for establishing packet information is cleared.

20. The method for operating a wireless access point as claimed in claim 19, wherein said step of checking whether information of said packet exists in said virtual mapping table is performed by a maintenance program that is executed regularly.

21. The method for operating a wireless access point as claimed in claim 7, wherein if the packet captured by said virtual bridging control module of said wireless access point is received by said RF module, said step of executing a packet processing program in said virtual bridging control module comprises the steps of:
determining the type of said packet;
checking whether information of said packet exists in a virtual mapping table;
modifying the information of said packet according to said virtual mapping table;
determining whether said packet is to be emitted by said RF module of said wireless access point; and
emitting out said packet via said RF module.

22. The method for operating a wireless access point as claimed in claim 21, wherein said step of determining the type of said packet includes determining whether said packet is a broadcast packet and determining whether said packet is an IP packet.

23. The method for operating a wireless access point as claimed in claim 21, wherein if said packet is determined to be a broadcast packet in said step of determining the type of said packet, said packet is transmitted to an operating system to be processed.

24. The method for operating a wireless access point as claimed in claim 23, wherein if said operating system cannot support the communication protocol of said packet, said packet is discarded.

25. The method for operating a wireless access point as claimed in claim 23, wherein if said packet can be processed by said operating system after the step of determining, said packet is sent out via an Ethernet port.

26. The method for operating a wireless access point as claimed in claim 23, wherein if said packet can be processed by said operating system after the step of determining, said step of determining the type of said packet is continued.

27. The method for operating a wireless access point as claimed in claim 21, wherein if said packet is determined to be not an IP packet in said step of determining the type of said packet, said packet is transmitted to an operating system to be processed.

28. The method for operating a wireless access point as claimed in claim 27, wherein if said operating system cannot support the communication protocol of said packet, said packet is discarded.

29. The method for operating a wireless access point as claimed in claim 27, wherein if said packet can be processed by said operating system after the step of determining, said packet is sent out via an Ethernet port.

30. The method for operating a wireless access point as claimed in claim 27, wherein if said packet can be processed by said operating system after the step of determining, said step of determining the type of said packet is continued.

31. The method for operating a wireless access point as claimed in claim 21, wherein if information of said packet does not exist in said virtual mapping table, said packet is transmitted to an operating system to be processed.

32. The method for operating a wireless access point as claimed in claim 31, wherein if said operating system cannot support the communication protocol of said packet, said packet is discarded.

33. The method for operating a wireless access point as claimed in claim 31, wherein if said packet can be processed by said operating system after the step of determining, said packet is sent out via an Ethernet port.

34. The method for operating a wireless access point as claimed in claim 31, wherein if said packet can be processed by said operating system after the step of determining, said step of determining the type of said packet is continued.

35. The method for operating a wireless access point as claimed in claim 21, wherein if it is determined that said packet is not to be emitted out via said RF module of said wireless access point, said packet is transmitted to an operating system to be processed.

36. The method for operating a wireless access point as claimed in claim 35, wherein if said operating system cannot support the communication protocol of said packet, said packet is discarded.

37. The method for operating a wireless access point as claimed in claim 35, wherein if said packet can be processed by said operating system after the step of determining, said packet is sent out via an Ethernet port.

38. The method for operating a wireless access point as claimed in claim 35, wherein if said packet can be processed by said operating system after the step of determining, said step of determining the type of said packet is continued.

39. The method for operating a wireless access point as claimed in claim 21, wherein when checking whether information of said packet exists in said virtual mapping table, the time for establishing said virtual mapping table is immediately updated, and too long time for establishing packet information is cleared.

40. The method for operating a wireless access point as claimed in claim 39, wherein said step of checking whether information of said packet exists in said virtual mapping table is performed by a maintenance program that is executed regularly.
